(19) United States
(12) Patent Application Publication
(10) Pub. No.: US 2009/0252929 A1
(43) Pub. Date: Oct. 8, 2009

(54) FOAM MOLDING MOLD STRUCTURE, MOLDING METHOD OF FOAM MOLDED PRODUCT, AND FOAM MOLDED PRODUCT

(75) Inventor: Takahisa Egawa, Hamamatsu-Shi (JP)

Correspondence Address: DARBY & DARBY P.C., P.O. BOX 770, Church Street Station, New York, NY, 10008-0770, US

(73) Assignee: Suzuki Motor Corporation, Hamamatsu-Shi (JP)

(21) Appl. No.: 12/389,488

(22) Filed: Feb. 20, 2009

(30) Foreign Application Priority Data
Apr. 3, 2008 (JP) 2008-097519

(51) Int. Cl. B32B 3/26; B29C 44/34; B29C 44/58

(52) U.S. Cl. 428/158; 425/4 R; 264/41

(57) ABSTRACT

In a state that a fixed mold and a movable mold are matched with each other, a molten resin is filled into a cavity. In this state, a movable nest is set in a position retired from a mold matching surface of the movable mold by a predetermined distance, its surface in a fixed mold side functioning as a cavity surface, and the molten resin is filled as far as a nest fitting portion. Then, only the movable mold is made to move backward in a mold opening direction (in an arrow direction in the drawing) by the predetermined distance to release a pressure and foam the molten resin, whereby a foam molded product is molded in which a strength of part thereof is improved.

### CROSS-REFERENCE TO RELATED APPLICATIONS

This application is based upon and claims the benefit under 35 U.S.C. § 119 of Japanese Patent Application No. 2008-097519, filed on Apr. 3, 2008, which is hereby incorporated by reference herein in its entirety.

### BACKGROUND OF THE INVENTION

[Field of the Invention]

The present invention relates to a foam molding mold structure or the like to mold a foam molded product by making a movable mold move in relation to a fixed mold, and more detailedly, relates to a foam molding mold structure or the like to improve a strength of a projecting portion or a recessed portion in the foam molded product.

[Description of the Related Art]

Conventionally, there is used a molding method in which a molten resin is filled into a cavity and a movable mold is made to move by a predetermined distance in a mold opening direction, whereby a foam molded product is obtained (for example, see Patent Document 1).

FIG. 9A and FIG. 9B show a conventional foam molding mold structure. In FIG. 9A and FIG. 9B, a reference numeral 101 indicates a fixed mold. A reference numeral 102 indicates a movable mold which is movable in relation to the fixed mold 101. A reference numeral 103 indicates a cavity being a space generated at a time that the fixed mold 101 and the movable mold 102 are matched with each other. A reference numeral 104 indicates a sprue being a passage to fill a molten resin into the cavity 103. A reference numeral 105 indicates an injection device to supply a molten resin to the sprue 104. Further, a reference numeral 101a indicates a recessed portion formed in a cavity surface of the fixed mold 101, the recessed portion 101a being to form a projecting portion in a foam molded product.

At a time of performing foam molding in the foam molding mold structure described above, first, as referred to in FIG. 9A, the molten resin is filled into the cavity 103. Then, as referred to in FIG. 9B, the movable mold 102 is made to move by a predetermined distance (L) in a mold opening direction (an arrow in the drawing) to release a pressure, whereby a foam molded product is molded. When such foam molding is performed, as referred to in FIG. 10, a foam molded product 150 is molded in which a projecting portion 151 is formed integrally with a base portion 152.

[Patent Document 1] Japanese Laid-open Patent Publication No. 2002-120252

As referred to in FIG. 10, a projecting portion 151 is formed integrally with a base portion 152 of a foam molded product 150 by means of a recessed portion 101a of a fixed mold 101. Such a foam molded product 150 is ordinarily molded with a skin layer A having a high resin density and a foaming layer B having a comparatively low resin density being in a state of mixedly existing, and basically an outer shell is constituted with the skin layer A and the inside thereof is constituted with the foaming layer B.

However, in a foam molded product of such a kind, there is a problem that since the projecting portion 151 is only held by the thin skin layer A, its strength is quite weak and that the projecting portion 151 is easily folded at a root portion when a large load acts on the projecting portion 151.

Further, though not illustrated specifically, there is also a problem that when a recessed portion to fit a member thereinto is formed in a foam-molded product a holding strength of the member fitted into the recessed portion becomes quite weak.

### SUMMARY OF THE INVENTION

The present invention is made to solve such problems, and an object of the present invention is to improve a strength of a projecting portion or a recessed portion in a foam molded product.

A foam molding mold structure of the present invention is a foam molding mold structure in which a foam molded product is molded by a molten resin being filled into a cavity formed by a movable mold and a fixed mold and the movable mode being made to move in relation to the fixed mold, the foam molding mold structure including: in at least either one of cavity surfaces of the movable mold and the fixed mold, a cavity surface movable relatively to the cavity surface.

The foam molding mold structure of the present invention includes a recessed portion or a projecting portion formed in a cavity surface facing the cavity surface movable relatively.

The foam molding mold structure of the present invention includes a recessed portion or a projecting portion formed in the cavity surface movable relatively.

Further, in the foam molding mold structure of the present invention, the recessed portion is to form at least one of a rib, a boss, a clip stay, and a tab shape in the foam molded product.

The foam molding mold of the present invention includes a movable nest constituting the cavity surface movable relatively.

A manufacturing method of a foam molded product of the present invention is a manufacturing method of a foam molded product using a foam molding mold structure including, in at least either one of cavity surfaces of a movable mold and a fixed mold, a cavity surface movable relatively to the cavity surface, the method including: filling a molten resin into a cavity formed by the movable mold and the fixed mold; and, when the movable mold is made to move in relation to the fixed mold, making the cavity surface movable relatively move relatively to a cavity surface having the cavity surface movable relatively.

A foam molded product of the present invention is a foam molded product including: a base portion; and a projecting portion or a recessed portion formed in the base portion, wherein in the base portion, a proportion of a foaming layer having a foaming magnification equal to or more than a predetermined foaming magnification in a thickness direction of a predetermined region in which the projecting portion or the recessed portion is formed is lower than a proportion of the foaming layer having the foaming magnification equal to or more than the predetermined foaming magnification in a thickness direction of a region other than the predetermined region.

Further, in the foam molded product of the present invention, in the base portion, all in the thickness direction of the predetermined region is constituted with a low foaming layer having a lower foaming magnification than the predetermined foaming magnification or with a non-foaming layer.

### BRIEF DESCRIPTION OF THE DRAWINGS

FIG. 1 is a view showing an injection molding machine having a foam molding mold structure according to the present invention;

FIG. 2A and FIG. 2B are views explaining a molding method according to a first embodiment of the present invention;

FIG. 3A and FIG. 3B are cross-sectional views of foam-molded products molded by the molding method according to the first embodiment of the present invention;

FIG. 4A to FIG. 4D are views showing examples of a foam-molded product molded by the molding method of the first embodiment of the present invention;

FIG. 5A to FIG. 5C are views showing modification examples of the foam molding mold structure according to the first embodiment;

FIG. 6A to FIG. 6B are views explaining a molding method according to a second embodiment of the present invention;

FIG. 7 is a cross-sectional view of a foam-molded product molded by the molding method of the second embodiment of the present invention;

FIG. 8A to FIG. 8C are views showing modification examples of the foam molding mold structure according to the second embodiment;

FIG. 9A and FIG. 9B are views explaining conventional foam molding; and

FIG. 10 is a cross-sectional view of a foam-molded product molded by the conventional foam molding.

### DETAILED DESCRIPTION OF THE PREFERRED EMBODIMENTS

Hereinafter, embodiments of the present invention will be described.

### First Embodiment

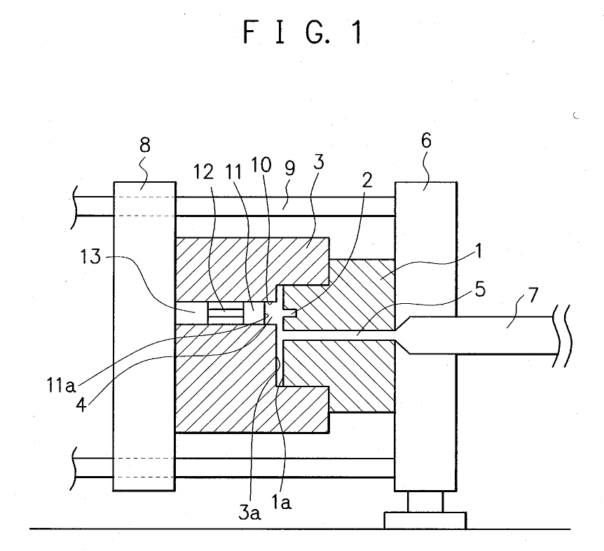

FIG. 1 is a view showing an injection molding machine having a foam molding mold structure according to a first embodiment. This injection molding machine has a foam molding mold structure to mold a foam-molded product having a projecting portion.

In FIG. 1, a reference numeral 1 indicates a fixed mold. A reference numeral 2 indicates a recessed portion formed in a cavity surface 1a of the fixed mold 1, the cavity surface 1a being to form a projecting portion such as a rib, a boss, a clip-stay or a tab shape in the foam molded product. A reference numeral 3 indicates a movable mold which moves (moves forward and backward) in relation to the fixed mold 1. A reference numeral 4 indicates a cavity being a space generated in a state that the fixed mold 1 and the movable mold 3 are matched with each other, and into the cavity 4 a molten resin is filled. A reference numeral 5 indicates a sprue boredly provided in the fixed mold 1, the sprue 5 being a passage through which the molten resin is filled into the cavity 4.

A reference numeral 6 indicates a fixed plate to hold the fixed mold 1. A reference numeral 7 indicates an injection device fixed to the fixed plate 6, the injection device 7 injecting and filling the molten resin into the cavity 5 via the sprue 5. A reference numeral 8 indicates a movable plate holding the movable mold 3, the movable plate 8 being constituted movable in a horizontal direction, and thereby the movable mold 3 moves forward and backward in relation to the fixed mold 1. A reference numeral 9 indicates a tie bar supporting the movable plate 8 and making the movable plate 8 movable. The tie bar 9 is constituted with a ball screw and a drive motor, or a hydraulic cylinder or the like.

A reference numeral 10 indicates a nest fitting portion boredly provided in the movable mold 3, the nest fitting portion 10 penetrating through the movable mold 3 and the movable plate 8 and opening in a cavity surface 3a. A reference numeral 11 indicates a movable nest insertedly provided in a manner to be movable in the nest fitting portion 10. Here, the movable nest 11 and the recessed portion 2 formed in the cavity surface 1a of the fixed mold 1 are in a positional relation of facing each other. A reference numeral 12 indicates a plunger which couples with the movable nest 11 and moves forward and backward. A reference numeral 13 indicates a drive mechanism portion driving the plunger 12. The drive mechanism portion 13 is disposed in the movable mold 3, and is constituted with a ball screw and a drive motor, or a hydraulic cylinder or the like. Depending on a disposition position of the projecting portion such as the rib, the boss, the clip stay or the tab shape, the movable nest 11 can be contacted with the fixed mold 1 by a spring, a hydraulic cylinder, a gas cylinder or the like so that a thickness of the cavity is held.

In the foam molding mold structure as above, a front end surface of the movable nest 11 constitutes part of the cavity surface 3a of the movable mold 3, so that the cavity surface 3a has a cavity surface 1a which is movable relatively to the cavity surface 3a.

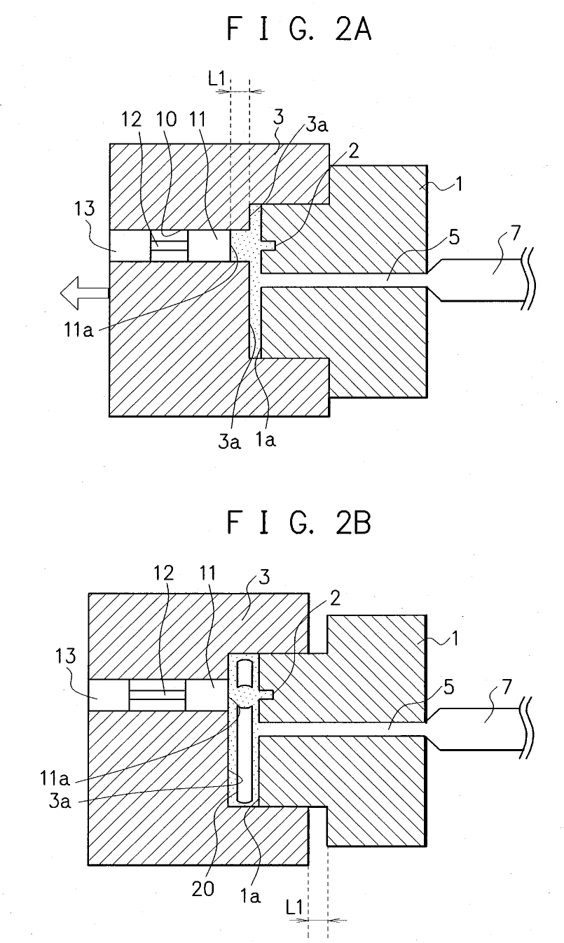

Next, a foam molding method by the injection molding machine constituted as above according to the present embodiment will be described by using FIG. 2A and FIG. 2B.

First, as referred to in FIG. 2A, in a state that the fixed mold 1 and the movable mold 3 are matched with each other, the molten resin is injected and filled into the cavity 4. In this state, a position of the movable nest 11 is set to be a position retired from the cavity surface 3a of the movable mold 3 by a predetermined distance (L1). Therefore, the molten resin is filled as far as the nest fitting portion 10. Here, the predetermined distance (L1) is a value determined in accordance with a size of a finished foam molded product, and is set to be a value capable of sufficiently securing a strength of a projecting portion formed by the recessed portion 2.

Then, as referred to in FIG. 2B, the movable mold 3 is made to move backward by the predetermined distance (L1) in a mold opening direction (in an arrow direction in the drawing) from the state of FIG. 2A to release a pressure, whereby the molten resin is foamed and a foam molded product 20 is molded. On this occasion, the movable nest 11 is made not to move from the position set in the above. In other words, the drive mechanism portion 13 makes the movable nest 11 move by the predetermined distance (L1) in a direction reverse to a backward movement direction of the movable mold 3. Therefore, when the movable mold 3 is made to move backward by the predetermined distance (L1), the cavity surface 3a of the movable mold 3 and the cavity surface 1a of the movable nest 11 become almost flat.

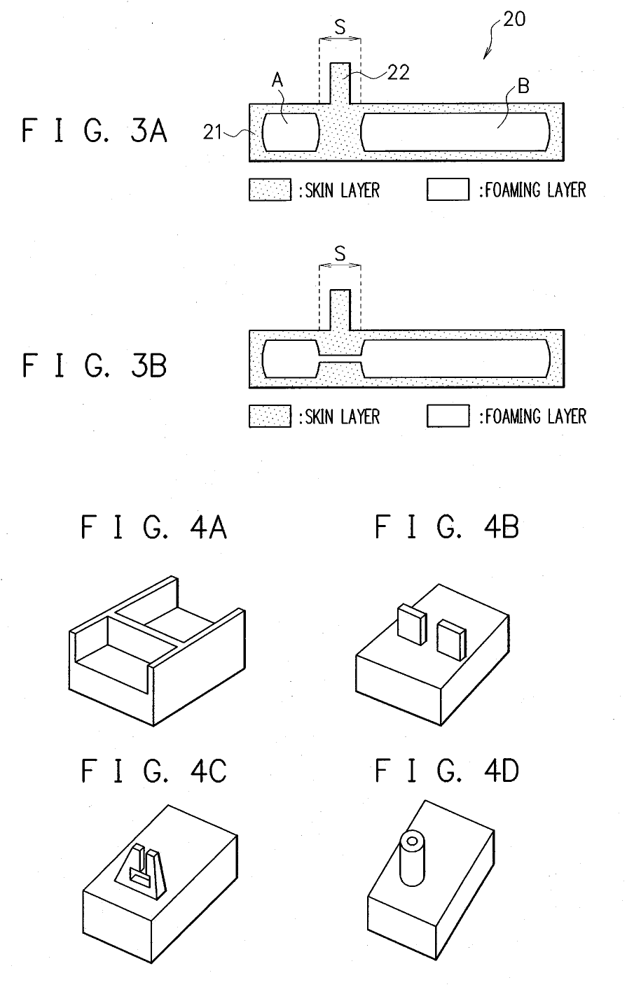

When the foam molding is performed as described above, as referred to in FIG. 3A, the foam molded product 20 in which a projecting portion 22 is formed integrally with a base portion 21 is molded. FIG. 3A is a cross-sectional view of the foam molded product 20. As referred to in FIG. 3A, the foam molded product 20 is molded with a skin layer A and a skin layer B being in a state of mixedly existing, and an outer shell of the base portion 21, the projecting portion 22, and all in a thickness direction of a predetermined region S on which the projecting portion 22 is formed in the base portion 21 are constituted with the skin layer A. This is because, when the movable mold 3 is made to move backward for foaming, the molten resin (in other words, the molten resin positioned from the cavity 4 to the nest fitting portion 10) existing in the thickness direction does not flow from the predetermined region S since the movable nest 11 is not made to move and foaming does not occur. It should be noted that the predetermined region S means a region set by the cavity surface 11a of the movable nest 11, and is a region which includes at least a root portion of the projecting portion 22.

Here, in this specification, a foaming layer means a layer whose foaming magnification is equal to or more than a predetermined foaming magnification, while a skin layer means a low foaming layer whose foaming magnification is lower than the predetermined foaming magnification or a non-foaming layer.

In such a foam molded product 20, the projecting portion 22 can be held by the thick skin layer A, so that a strength of the projecting portion 22 can be improved. Therefore, even when a large load acts on the projecting portion 22, it is possible to solve a problem that the projecting portion 22 is easily folded at the root portion, and so on.

It should be noted that though in the present embodiment an example is explained in which all in the thickness direction of the predetermined region S is constituted with the skin layer A in the base portion 21 as referred to in FIG. 3A, an effect of improving the strength of a projecting portion 22 can be obtained even if a thin foaming layer B exists in a thickness direction of a predetermined region S as referred to in FIG. 3B. In other words, it suffices that, in the base portion 21, a proportion of the foaming layer B in the thickness direction of the predetermined region S is lower than a proportion of the foaming layer B in a thickness direction of a region other than the predetermined region S.

FIG. 4A to FIG. 4D show concrete examples of foam molded products which can be molded by the injection molding machine according to the present embodiment. By the injection molding machine according to the present embodiment, foam molded products, for example, shown in FIG. 4A to FIG. 4D can be molded, and it is possible to mold a foam molded product in which a strength of a projecting portion such as a rib, a boss, a clip stay or a tab shape as referred to in FIG. 4A to FIG. 4D is improved.

As stated above, in the present embodiment, a movable nest 11 which can move forward and backward in a movable mold 3 is provided, and the movable nest 11 is disposed in a position facing a recessed portion 2 of a fixed mold 1 for molding of a projecting portion such as a rib. Then, at a time of filling of a molten resin, the movable nest 11 is set in a position retired from a mold matching surface 3a in correspondence with a thickness of a foam molded product, the movable nest 11 constituting a cavity surface, and then the molten resin is filled into a cavity 4, and the movable nest 11 is made not to move in relation to the movable mold 3 when the movable mold 3 moves backward at the foam molding time. Thereby, a portion positioned in a thickness direction of a predetermined region S including a root portion of a projecting portion 22 formed by the recessed portion 2 of the fixed mold 1 can be made constituted with a skin layer A, so that the foam molded product in which a strength of the projecting portion 22 is improved can be obtained.

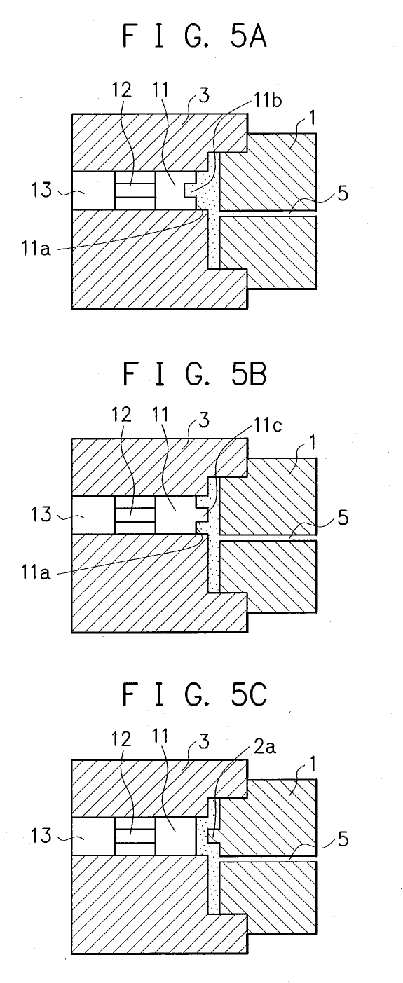

Further, in a constitution in which the movable nest 11 is insertedly provided in the movable mold 3 as in the present embodiment, as a modified example, there can be formed a recessed portion 11b in a cavity surface 11a of a movable nest 11 as referred to in FIG. 5A, to mold a foam molded product having a projecting portion.

Further, as referred to in FIG. 5B, a projecting portion 11c can be formed in a cavity surface 11a of a movable nest 11, to mold a foam molded product having a recessed portion. Otherwise, as referred to in FIG. 5C, a projecting portion 2a can be formed in a position facing a movable nest 11 in a cavity surface 1a of a fixed mold 1, to mold a foam molded product having a recessed portion. In constitutions of FIG. 5B and FIG. 5C, foam molded products can be obtained in which strengths of recessed portion and the like formed to fit members thereinto are improved.

### Second Embodiment

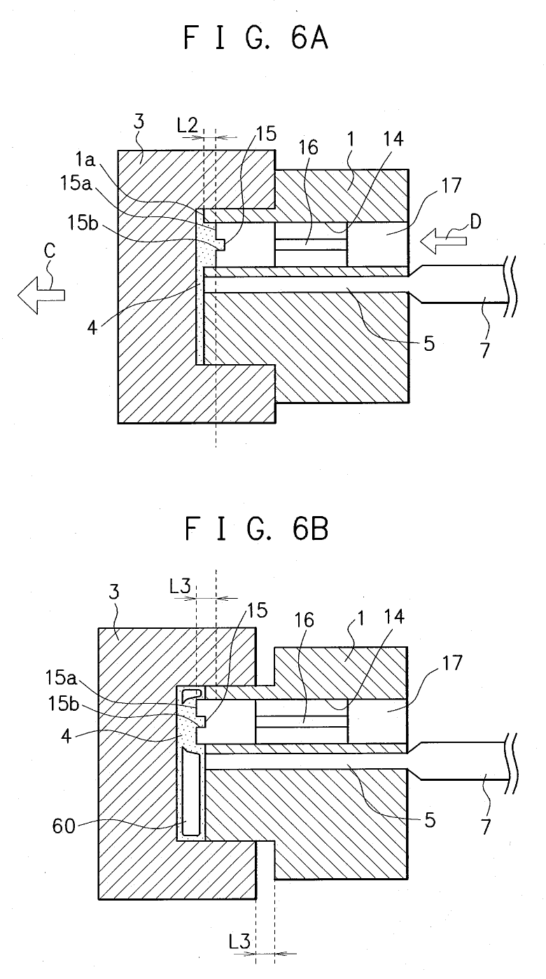

Next, a second embodiment of the present invention will be described. FIG. 6A and FIG. 6B are views showing a foam molding mold structure according to the present embodiment and explaining a foam molding method according to the present embodiment. It should be noted that in FIG. 6A and FIG. 6B members common to those of the first embodiment are represented by the same reference numerals, and an injection molding machine using the foam molding mold structure according to the present embodiment is similar to that in the first embodiment and so description thereof will be omitted. The present embodiment is different from the first embodiment in that a movable nest 15 is provided in a fixed mold 1. Hereinafter, details will be described.

In FIG. 6A and FIG. 6B, a reference numeral 14 indicates a nest fitting portion boredly provided in the fixed mold 1, the nest fitting portion 14 penetrating through the fixed mold 1 and opening in a cavity surface 1a. A reference numeral 15 indicates a movable nest insertedly provided in a manner to be slidable in the nest fitting portion 14. A reference numeral 15a indicates a cavity surface, while a reference numeral 15b indicates a recessed portion formed in the cavity surface 15a, the recessed portion 15b being to form a projecting portion such a rib, a clip stay, a boss or a tab shape in a molded product. A reference numeral 16 indicates a plunger which couples with the movable nest 11 and makes the movable nest 15 move forward and backward. A reference numeral 17 indicates a drive mechanism portion driving the plunger 16. The drive mechanism portion 17 is disposed in the fixed mold 1 and constituted with a ball screw and a drive motor, or a hydraulic cylinder or the like. Further, depending on a disposition position of the projecting portion such as the rib, the boss, the clip stay or the tab shape, the movable nest 15 can be contacted with the movable mold 3 by a spring, a hydraulic cylinder, a gas cylinder or the like and can move in accordance with a movement of the movable mold 3.

A foam molding method in the foam molding mold structure constituted as above will be described.

First, as referred to in FIG. 6A, in a state that the fixed mold 1 and the movable mold 3 are matched with each other, a molten resin is injected and filled into a cavity 4. In this state, a position of the movable nest 15 is set to be a position retired from a mold matching surface 1a of the fixed mold 1 by a predetermined distance (L2). Therefore, the molten resin is filled as far as the nest fitting portion 14. Here, the predetermined distance (L2) is a value determined in accordance with a size of a finished foam molded product, and is set to be a value capable of sufficiently securing a strength of a projecting portion formed by the recessed portion 15a.

Then, as referred to in FIG. 6B, the movable nest 3 is made to move backward by a predetermined distance (L3) in a mold opening direction (in an arrow C direction in the drawing) from a state of FIG. 6A, and the movable nest 15 is also made move forward by the predetermined distance (L3) (in an arrow D direction in the drawing, and here, a forward movement direction of the movable nest 15 is a backward movement direction of the movable mold 3).

As a result that the movable mold 3 is made to move backward and the movable nest 15 is made to move forward as described above, a foam molded product 60 is molded by a pressure of a predetermined portion of the molten resin filled into the cavity 4 being released and the predetermined portion being foamed but the other portion being not foamed.

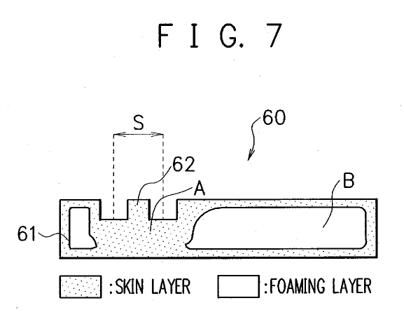

FIG. 7 is a cross-sectional view of the foam molded product 60 molded as described above. In the foam molded product 60, a projecting portion 62 is formed integrally with a base portion 61, and as referred to in FIG. 7, the foam molded product 60 is molded with a skin layer A and a skin layer B being in a state of mixedly existing. An outer shell of the base portion 61, the projecting portion 62, and all in a thickness direction of a predetermined region S on which the projecting portion 62 is formed in the base portion 61 are constituted with the skin layer A. This is because, when the movable mold 3 is made to move backward for foaming, the molten resin (in other words, the molten resin positioned from the cavity 4 to the nest fitting portion 14) existing in the thickness direction does not flow from a predetermined region S since the movable nest 15 is made to move forward synchronously with the movable mold 3, and foaming does not occur. It should be noted that the foaming layer and the skin layer are similar to those explained in the first embodiment. Further, the predetermined region S means a region set by the cavity surface 15a of the movable nest 15, and is a region which includes at least a root portion of the projecting portion 62.

In the foam molded product 60 as above, the projecting portion 62 can be held by the thick skin layer A, so that a strength of the projecting portion 62 can be improved. Therefore, even when a large load acts on the projecting portion 62, it is possible to solve a problem that the projecting portion 62 is easily folded at the root portion, and so on.

As stated above, in the present embodiment, a movable nest 15 which can move forward and backward in a fixed mold 1 is provided, and a recessed portion 15b to mold a projecting portion such as a rib is provided in the movable nest 15. Then, at a time of filling of a molten resin, the movable nest 15 is set in a position retired from a mold matching surface 1a by a predetermined distance in correspondence with a thickness of a foam molded product, the movable nest 15 constituting a cavity surface, and then the molten resin is filled into a cavity 4, and the movable nest 15 is made to move forward synchronously with the movable mold 3 when a movable mold 3 is made to move backward at a foam molding time. Thereby, a portion positioned in a thickness direction of a predetermined region S including a root portion of a projecting portion 62 formed by the recessed portion 15b of the movable mold 15 can be made constituted with a skin layer A, so that the foam molded product in which a strength of the projecting portion 62 is improved can be obtained.

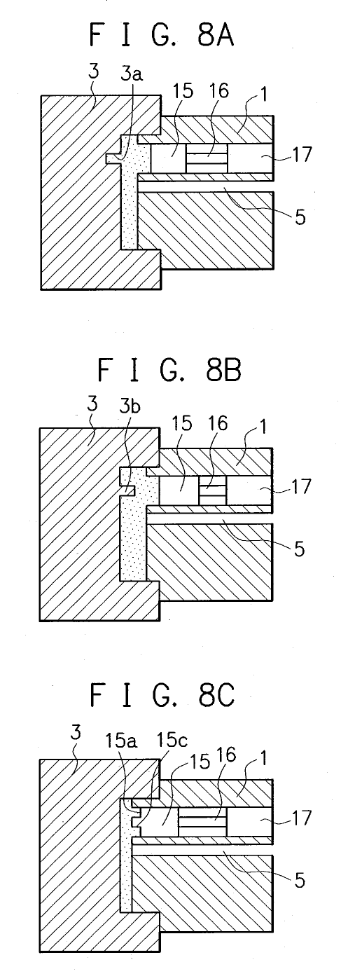

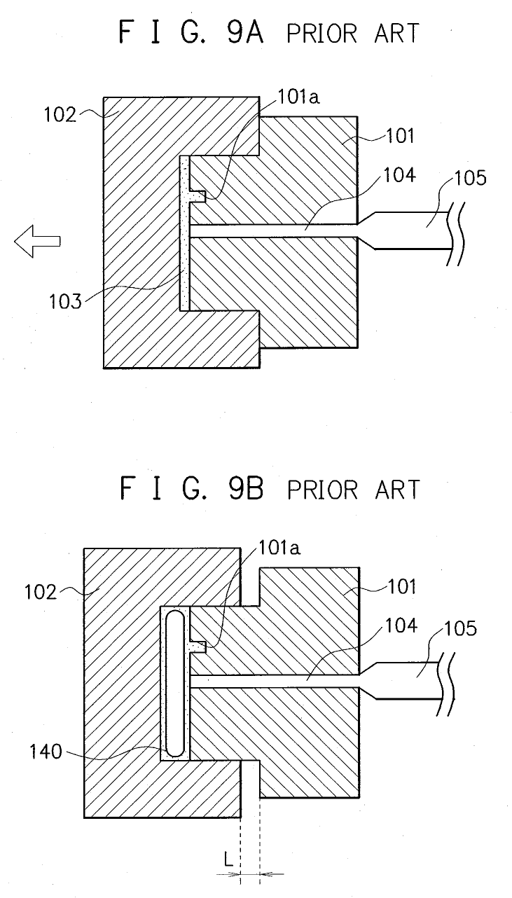

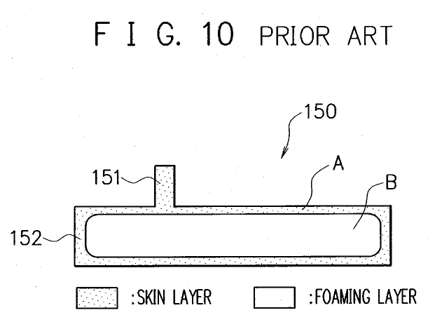

Further, in a constitution in which the movable nest 15 is insertedly provided in the fixed mold 1 as in the present embodiment, as a modified example there can be formed a recessed portion 3a in a movable mold 3 as referred to in FIG. 8A, to mold a foam molded product having a projecting portion.

Further, as referred to in FIG. 8B, a projecting portion 3b can be formed in a movable mold 3, to mold a foam molded product having a recessed portion. Otherwise, as referred to in FIG. 8C, a projecting portion 15c can be formed in a cavity surface 15a of a movable nest 15, to mold a foam molded product having a recessed portion. In constitutions of FIG. 8B and FIG. 8C, foam molded products can be obtained in which strengths of recessed portion and the like formed to fit members thereinto are improved.

It should be noted that in the first and the second embodiment, the movable nest 11 or 15 can be constituted attachable/detachable in accordance with a shape of the foam molded product. It is also possible to constitute so that a nest having a predetermined shape can be additionally mounted to the movable nest 11 or 15. It is also possible to constitute so that a nest having a predetermined shape can be additionally mounted in the fixed mold 1 or the movable mold 3. By a constitution in which the nest is attachable/detachable or mountable, it is possible to cope with foam molded products having various shapes.

Further, in the first and the second embodiments, it is described that the drive mechanisms to enable the movable mold 3 and the movable nest 11 or 15 move are each constituted with a ball screw and a drive motor, or a hydraulic cylinder or the like. However, in the present embodiment, since it is preferable to perform an accurate core-back control by accurately recognizing an initial position of the movable nest 11 or 15 or by accurately synchronizing the movable nest 15 with the movable mold 3 in order to improve quality of a foam molded product, it is desired that the movable nest 11 or 15 is made contact with the facing fixed mold 1 or movable mold 3 with a cylinder, a spring or the like so that a thickness of a cavity can be accurately controlled at a time of opening the mold.

Further, the constitution of the first embodiment and the constitution of the second embodiment can be implemented combinedly, and the number of movable nests can be plural. Though in the present embodiments the projecting portion or the recessed portion is formed in the movable nest, the fixed mold or the movable mold to improve the strength of the projecting portion or the like in the foam molded product, the present embodiments are also effective for a foam molded product in which a projecting portion is not formed, and in such a case, a strength of a predetermined portion of the foam molded product can be improved.

As the molten resin used in the present invention, a thermoplastic resin is preferable, and a chemical foaming agent can be used or a physical foaming agent can be used.

According to the present invention, when a projecting portion such as a rib, a boss, a clip stay or a tab shape, or a recessed portion to fit a member thereinto is integrally formed in a foam molded product, it is possible to improve a strength of the projecting portion or the recessed portion.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A foam molding mold structure in which a foam molded product is molded by a molten resin being filled into a cavity formed by a movable mold and a fixed mold and the movable mode being made to move in relation to the fixed mold, the foam molding mold structure comprising:
in at least either one of cavity surfaces of the movable mold and the fixed mold, a cavity surface movable relatively to the cavity surface.

2. The foam molding mold structure according to claim 1, comprising:
a recessed portion or a projecting portion formed in a cavity surface facing said cavity surface movable relatively.

3. The foam molding mold structure according to claim 2, wherein
said recessed portion is to form at least one of a rib, a boss, a clip stay, and a tab shape in the foam molded product.

4. The foam molding mold structure according to claim 1, comprising:
a movable nest constituting said cavity surface movable relatively.

5. The foam molding mold structure according to claim 2, comprising:
a movable nest constituting said cavity surface movable relatively.

6. The foam molding mold structure according to claim 3, comprising:
a movable nest constituting said cavity surface movable relatively.

7. The foam molding mold structure according to claim 1, comprising:
a recessed portion or a projecting portion formed in said cavity surface movable relatively.

8. The foam molding mold structure according to claim 7, wherein
said recessed portion is to form at least one of a rib, a boss, a clip stay, and a tab shape in the foam molded product.

9. The foam molding mold structure according to claim 7, comprising:
a movable nest constituting said cavity surface movable relatively.

10. The foam molding mold structure according to claim 8, comprising:
a movable nest constituting said cavity surface movable relatively.

11. A manufacturing method of a foam molded product using a foam molding mold structure comprising, in at least either one of cavity surfaces of a movable mold and a fixed mold, a cavity surface movable relatively to the cavity surface, the method comprising:
filling a molten resin into a cavity formed by the movable mold and the fixed mold; and
when the movable mold is made to move in relation to the fixed mold, making the cavity surface movable relatively move relatively to a cavity surface having the cavity surface movable relatively.

12. A foam molded product comprising:
a base portion; and
a projecting portion or a recessed portion formed in said base portion, wherein
in said base portion, a proportion of a foaming layer having a foaming magnification equal to or more than a predetermined foaming magnification in a thickness direction of a predetermined region in which said projecting portion or the recessed portion is formed is lower than a proportion of the foaming layer having the foaming magnification equal to or more than the predetermined foaming magnification in a thickness direction of a region other than the predetermined region.

13. The foam molded product according to claim 12, wherein
in said base portion, all in the thickness direction of the predetermined region is constituted with a low foaming layer having a lower foaming magnification than the predetermined foaming magnification or with a non-foaming layer.
